(19) United States
(12) Patent Application Publication
(10) Pub. No.: US 2013/0046715 A1
(43) Pub. Date: Feb. 21, 2013

(54) METHOD TO DETERMINE AN ARTIFICIAL LIMB MOVEMENT FROM AN ELECTROENCEPHALOGRAPHIC SIGNAL

(71) Applicants: Thierry Castermans, Honelles (BE); Thierry Dutoit, Sirault (BE); Matthieu Duvinage, Braine-le-Comte (BE)

(72) Inventors: Thierry Castermans, Honelles (BE); Thierry Dutoit, Sirault (BE); Matthieu Duvinage, Braine-le-Comte (BE)

(73) Assignee: UNIVERSITE DE MONS, Mons (BE)

(21) Appl. No.: 13/521,339

(22) PCT Filed: Jan. 11, 2011
(86) PCT No.: PCT/EP11/50260

§ 371 Date: Nov. 7, 2012

Related U.S. Application Data
(60) Provisional application No. 61/293,893, filed on Jan. 11, 2010.

(51) Int. Cl. G06F 15/18

(52) U.S. Cl. 706/12

(57) ABSTRACT

The present invention is related to a method to determine an artificial limb movement comprising the steps of: providing an EEG input training dataset; providing an output prosthetic limb movement training dataset corresponding to said EEG input training dataset; providing a dynamic recurrent neural network (DRNN) comprising a convergence acceleration algorithm; training said DRNN with said input and output datasets to define synaptic weights Wᵢ₋ⱼ, between neurons of said DRNN; determining from any EEG input dataset the artificial limb movement using the output generated by the trained DRNN in response to said EEG input dataset.

### FIELD OF THE INVENTION

The present invention is related to a method to determine artificial limb movement from electroencephalographic (EEG) signal.

### BACKGROUND

Current prostheses dedicated to disabled people or amputees generally use electromyographic (EMG) signals arising from the skin surface of the stump do not integrate the latest advances in the fields of neurophysiology, microelectronics and signal processing.

Such prostheses, are described by G. Cheron et Al. in “A dynamic recurrent neural network for multiple muscles electromyographic mapping to elevation angles of the lower limb in human locomotion”, Journal of Neuroscience Methods, 129(2):95-104, 2003. In that original context, the authors used the DRNN for simulating lower limb coordination in human locomotion. They demonstrated the DRNN was able to establish a mapping between the electromyographic signals (EMG) from six muscles and the elevation angles of the three main lower limb segments (thigh, shank and foot).

The use of such EMG signal is unfortunately not always possible, for example in the case of disabled patients suffering of spinal cord or motor nerves diseases.

### AIMS OF THE INVENTION

The present invention aims to provide a method for determining an artificial limb movement not based on EMG signals.

### SUMMARY OF THE INVENTION

A first aspect of the present invention is related to a method to determine an artificial limb movement comprising the steps of:
providing an EEG input training dataset;
providing an output prosthetic limb movement training dataset corresponding to said EEG input training dataset;
providing a dynamic recurrent neural network (DRNN) comprising a convergence acceleration algorithm;
training said DRNN with said input and output datasets to define synaptic weights w_{i,j} between neurons of said DRNN;
   determining from any EEG input dataset the artificial limb movement using the output generated by the trained DRNN in response to said EEG input dataset.

According to particular preferred embodiments, the method of the invention further discloses at least one or a suitable combination of the following features:
the artificial limb movement to be determined is a quasi-periodic limb movement;
the DRNN training step is further used to define all other free parameters of the DRNN;
the DRNN training step is further used to define time constants Tᵢ and bias Iᵢ;
the EEG signal and the EEG input training dataset are pre-processed by means of a blind source separation based algorithm;
the blind source separation algorithm is used to filter electromyographic (EMG) and electrooculographic (EGG) artifacts;
the EEG signal and the EEG input training dataset are pre-processed by means of Fourier analysis algorithm;
relevant information of both the EEG signal and the EEG input training dataset are extracted by means of an independent component analysis based algorithm;
the number of movement variables is reduced by using principal component analysis;
the training step is performed iteratively and a learning rate ε_{i,j} is associated with each neural connection from neuron i to neuron j, the learning rate ε_{i,j} being increased by a constant coefficient u at each iteration if the product of the gradient of the error function

$$\frac{\partial E}{\partial {w}_{ij}} ( n )$$

at the last two iterations is positive, and the learning rate ε_{i,j} being decreased by a constant coefficient d at each iteration if the product of gradient of the error function at the last two iterations is negative;
the constant coefficient u is comprised between 1.1 and 1.5 and the constant coefficient d is comprised between 0.5 and 0.9
if the error function E(n) increases between two iteration, all the learning rates are divided by a constant factor c:
   if E(n+1)>E(n) then ε_{i,j} (n+1)=(n)/c, for all i, j, c being a number larger than one, preferably comprised between 1.5 and 5;
additional learning rates are associated to all other free parameters of the DRNN;
the artificial limb movements to be determined corresponds to lower limb movements;
the determined movements are used to simulate corresponding electromyographic signals.

A second aspect of the invention is related to a Prosthetic limb system comprising:
prosthetic limb comprising servo-drive means to control prosthetic limb movement;
sensing means for sensing EEG signal originating from a user brain;
means for inputting the EEG signal to an artificial neural network;
means within said neural network for determining an artificial prosthetic limb movement from said EEG signal according to the method of the invention;
   wherein the output of said neural network is operatively connected to said servo-drive means to control the prosthetic limb movement.

Preferably, the artificial neural network of the prosthetic limb system of the invention is a dynamic recurrent neural network.

Advantageously, the prosthetic limb is corresponding to lower limb prosthesis.

The present invention is also related to a computer readable medium having computer readable code embodied therein, said computer readable code, when executed on a computer, implementing the method of the invention.

### BRIEF DESCRIPTION OF THE DRAWINGS

FIG. 1 represents a typical example of a training procedure where the error function increases with the number of iterations (original version of the DRNN).

FIG. 2 represents an improved behaviour of the error function (new version of the DRNN).

FIG. 3 represents the output of the original DRNN after training compared to the experimental curve of the first principal component of the leg kinematics (applied on learning dataset).

FIG. 4 represents the output of the original DRNN after training compared to the experimental curve of the second principal component of the leg kinematics (applied to the learning dataset).

FIG. 5 represents an application of the trained original DRNN on an independent testing dataset (first principal component of the leg kinematics).

FIG. 6 represents an application of the trained original DRNN on an independent testing dataset (second principal component of the leg kinematics).

FIG. 7 represents a simulation of the EMG signals on the basis of the corresponding EEG signals with the original DRNN. Convergence was observed for one muscle only.

FIG. 8 represents a simulation of the EMG signals on the basis of the corresponding EEG signals with the new DRNN. Convergence was observed for all muscles.

FIG. 9 represents a simulation of the EMG signals on the basis of the corresponding EEG signals with the new DRNN. Convergence was observed for all muscles.

FIG. 10 represents the independent components extracted from independent component analysis. In this case, the two first ICA components are clearly related to legs and walk.

FIG. 11 represents a homunculus, result of neuroscience. It is shown that the legs are controlled in the centre of the motor cortex.

FIG. 12 represents the elevation angles of the knee, the thigh and the shank.

FIG. 13 represents the first principal component determined by the new DRNN on a testing input data set (not used in the training phase).

FIG. 14 represents the second principal component determined by the new DRNN on a testing input data set (not used in the training phase).

FIG. 15 represents the readjustment of the output of the new DRNN in case of wrong initial output.

FIG. 16 represents the output of the DRNN in case of white noise as input data set.

FIG. 17 represents the output of the new DRNN in case of wrong phase initial conditions, showing that with ICA components, the DRNN is able to recover the phase.

FIG. 18 represents the output of the new DRNN in case of wrong phase initial conditions with white noise as input dataset.

FIG. 19 represents the first output of the trained new DRNN with zero as input dataset, this output is perfectly periodic after a transient.

FIG. 20 represents the second output of the trained new DRNN with zero as input dataset.

FIG. 21 represents the frequency distribution of the second ICA component, showing particular frequencies.

FIG. 22 represents the frequency distribution of the second component of kinematics showing the same particular frequencies as the second ICA component.

FIG. 23 represents the first component of ICA and the EMG of Left semitendinosus muscle showing high coherence for similar frequencies like for kinematics.

FIG. 24 represents first component of ICA and the EMG of Left Vastus lateralis muscle showing high coherence for similar frequencies like for kinematics.

FIG. 25 represents ERP analysis results showing a clear pattern in Cz and Fz coherent with the homunculus and the ICA components.

FIG. 26 represents ERP analysis results showing a clear pattern in Cz in the time frequency representation.

### DETAILED DESCRIPTION OF THE INVENTION

The present invention is related to a method for determining an artificial limb movement from electro encephalographic (EEG) measurement. The determined limb movement may then be used for example to drive a prosthetic limb. This determined movement may also be used for other applications, such as driving an avatar in virtual reality simulation, or the like.

The method of the invention may for example advantageously be used for driving a lower limb prosthesis.

Preferably, the EEG signal is pre-processed before being used for determining the artificial limb movement.

Advantageously, the pre-processing comprises an artefact removal step, a filtering step and relevant information extraction step based on Independent Component Analysis (ICA).

The artefact removal is preferably a blind source separation for filtering EMG and EOG artefacts. Then, a high pass filter (0.1 Hz) is preferably applied and relevant information is then advantageously obtained by using ICA.

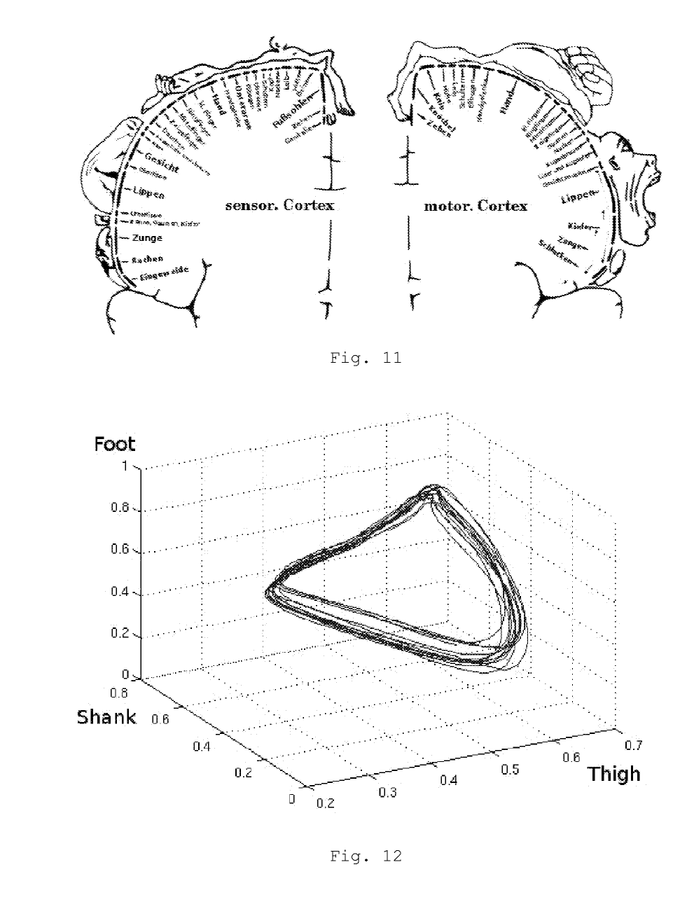

The choice of relevant decompositions are significant in their weight and significant in their location on the scalp. For example, for walk applications, the central motor area is of particular importance as shown in the homunkulus in FIG. 11.

Moreover, the use of high pass filtering on ICA component activations, directly named in the following sections ICA components, has proven its good effect on the final results.

The EEG signals, advantageously pre-processed to extract chosen ICA components are fed to a dynamic recurrent neural network (DRNN). The targets of the outputs of the DRNN may advantageously be the principal components of the different joints involved in the movement to be determined. It could also be directly the angular accelerations or speeds of the target movement. But, the use of principal component analysis (PCA) permits to reduce the number of variables.

In a first step, a learning dataset is provided to determine the DRNN parameters, such as synaptic weights and preferably the time constants and bias. This learning dataset comprises an input EEG signal, preferably pre-processed (ICA components) and the corresponding target movement of the artificial limb.

The DRNN used in the invention preferably uses neural network model governed by the following equations:

$${T}_{i} \frac{d {y}_{i}}{d t} = - {y}_{i} + F ( {x}_{i} ) + {I}_{i} \qquad ( 1 )$$

where F(α) is the squashing function F(α)=1/(1+e^{-α}, yᵢ is the state or activation level of unit i, Iᵢ is an external input (or bias), and xᵢ is given by:

Xᵢ=Σⱼwᵢⱼyⱼ (2)

which is the propagation equation of the network (xᵢ is called the total or effective input of the neuron, Wᵢⱼ is the synaptic weight between units i and j). The time constants Tᵢ act as a relaxation process. The correction of the time constants is included in the learning process in order to increase the dynamical features of the method.

The synaptic weights wᵢⱼ, time constants Tᵢ and biases Iᵢ are the free parameters of the DRNN.

Introduction of Tᵢ allows more complex frequential behaviour, improves the non-linearity effect of the sigmoid function and the memory effect of time delays.

The network consists of n fully-connected neurons. Therefore, each neurone in an n neurones network has n connections (including a self-connection). In order to make the temporal behaviour of the network explicit, an error function is defined as:

E=∫ₜ_{₀}^{t}^{₁}q(y(t),t)dt (3)

where t₀ and t₁ give the time interval during which the correction process occurs. The function q(y(t),t) is the cost function at time t which depends on the vector of the neurone activations y and on time. We then introduce new variables pᵢ (called adjoint variables) that will be determined by the following system of differential equations:

$$\frac{\partial {p}_{i}}{\partial t} = \frac{1}{{T}_{i}} {p}_{i} - {e}_{i} - {\sum }_{j} \frac{1}{{T}_{i}} {w}_{ij} {F}^{′} ( {x}_{j} ) {p}_{j} \qquad ( 4 )$$

with boundary conditions pᵢ(t₁)=0.
After the introduction of these new variables, the learning equations can be determined:

$$\begin{matrix}\frac{\partial E}{\partial {w}_{ij}} = \frac{1}{{T}_{i}} {\int }_{{t}_{0}}^{{t}_{1}} {y}_{i} {F}^{′} ( {x}_{j} ) {p}_{j} d t & ( 5 ) \\ \frac{\partial E}{\partial {T}_{i}} = \frac{1}{{T}_{i}} {\int }_{{t}_{0}}^{{t}_{1}} {y}_{i} {F}^{′} ( {x}_{j} ) {p}_{j} d t & ( 6 )\end{matrix}$$

Due to the integration of the system of (4) backward through time, this algorithm is sometimes called ‘backpropagation through time’.

More details on that preferred DRNN is described by Cheron et Al. in in “A dynamic recurrent neural network for multiple muscles electromyographic mapping to elevation angles of the lower limb in human locomotion”, Journal of Neuroscience Methods, 129(2):95-104, 2003. The DRNN described in this document will be referred hereafter as the original DRNN. The learning phase of this original DRNN is preferably modified as described hereafter. The modified DRNN will be referred hereafter as the new DRNN.

In a preferred method of the invention the synaptic weights are then adapted, using separate learning rate C_{i,j} for each connection (i.e. all the synaptic weights have their own adaptive learning rate).

In order to have converging learning procedure in a realistic timeframe, and with a limited learning dataset, a convergence acceleration algorithm is used during the learning phase.

Preferably, in the convergence acceleration algorithm, the adaptation of these learning rates is done by observing the sign of the gradient of the error function E at the two last iterations. As long as no change in sign is detected the corresponding learning rate is increased by a factor u, u being a number greater than 1. If the sign changes the learning rate is decreased by a factor d, d being a number comprised between 0 and 1. More formally, the algorithm can be written:
Small initial values are chosen for each ε_{i,j}, such as about 0.1;
At iteration n, the learning rate is adapted using the following conditional equations:

$$\frac{\partial E}{\partial {w}_{i , j}} ( n ) \frac{\partial E}{\partial {w}_{i , j}} ( n - 1 ) \geq 0 \qquad ( 7 )$$

### Then

ε_{i,j}(n)=ε_{i,j}(n−1)·u (8)

Else

ε_{i,j}(n)=ε_{i,j}(n−1)·d (9)

The connections w_{i,j} are then computed using the increment:

$$Δ {w}_{ij} ( n ) = - {ε}_{i , j} ( n ) \cdot \frac{\partial E}{\partial {w}_{ij}} \qquad ( 10 )$$

Preferably, the same procedure is applied at each iteration to the time constants Tᵢ and the biases Iᵢ, with additional learning rates, corresponding to each time constant Tᵢ and bias Iᵢ.

Preferably u is comprised between 1.1 and 1.5, more preferably, u is about 1.3. Preferably, d is comprised between 0.9 and 0.5, more preferably, d is about 0.7, the selected u and d giving the best convergence results.

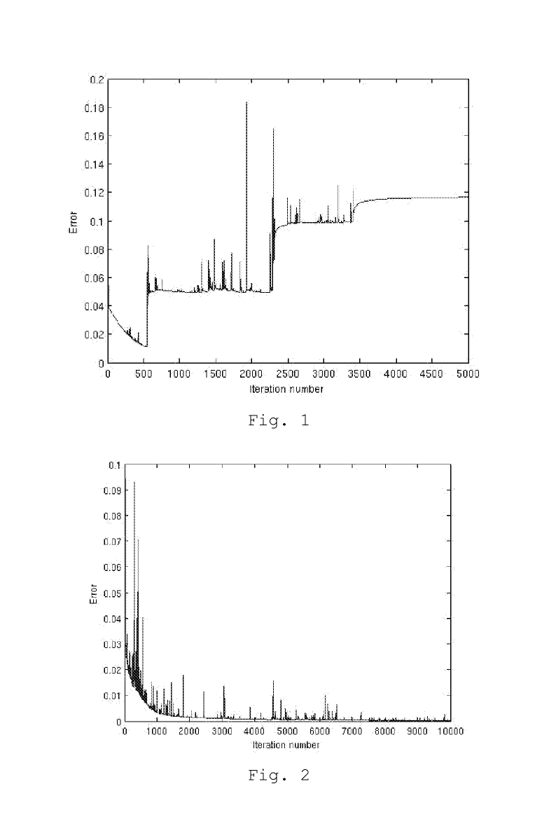

It was observed that this methodology could accelerate the convergence of the DRNN, but could also lead to an abnormal behavior, like a monotonic increase of the error E as a function of the iteration number, also called bifurcation (see in FIG. 1).

A new procedure was therefore developed (as part of the convergence acceleration algorithm), wherein it was checked at each iteration that the new learning rates ε_{i,j} does not give rise to bifurcations during the learning process. If so, all the learning rates are divided by a constant factor c larger than 1, preferably comprised between 1.5 and 5, more preferably about 2. For iteration number n, this test procedure can be mathematically described as:

If ε(n+1)>E(n)

then ε_{i,j} (n+1)=(n)/c, for all i, j.

This reduction is also preferably applied to the learning rates associated to the time constants and the biases.

This technique totally prevents the error of the DRNN to increase indefinitely. A typical behaviour of the error function during the learning phase is shown on FIG. 2.

In addition to this test procedure, the synaptic weights, time constants and biases values giving the lowest error throughout the whole learning procedure are also stored.

### DESCRIPTION OF A PREFERRED EMBODIMENT OF THE INVENTION

The present invention has been evaluated for determining a lower movement, comprising the elevation angles the shank, the knee and the thigh.

In a first step, a large set of recorded EEG signals with corresponding target movements were provided.

Then, a pre-processing was performed on the EEG signals, in order to extract relevant information from said EEG. In this example, the pre-processing is composed of artefact removal, filtering and relevant information extraction based on Independent Component Analysis (ICA). The artefact removal is actually a common BSS filtering for EMG and EOG artefacts. Then, a high pass filter (0.1 Hz) is applied and relevant information is obtained by using ICA depicted in FIG. 10. The use of high pass filtering on ICA component activations, directly named in the following sections ICA components, has proved its positive effect on the determination of the movement.

Then, the chosen ICA components are given as input in the DRNN. The targets of the outputs of the DRNN are for this example the principal components of the elevation angles of the shank, the knee and the thigh. It could also be the relative angles between shank, knee and thigh, angular accelerations or speeds. But, in order to reduce the dimensionality of the DRNN, the use of PCA can reduce by one the number of variables. Indeed, it has been shown that those 3 angles are linked together and not independent as depicted in FIG. 12. Finally, the learning procedure is applied.

Because no optimization method has been proven up to now to obtain the global minimum and to choose the best topology (number of hidden neurons), a high number of trainings (typically 200 trainings) for each topology of the DRNN was tested.

By topology, we mean the number of hidden neurons (the input and output numbers are fixed by the problem). For instance, for the results hereafter, 200 trainings for each topology were used. Each tested topology had a number of hidden neurons between 1 and 20 (this number depends on the complexity of the system; the periodic signal allows to diminish this number). For each topology, the best network in terms of error is saved, then the best of those best networks is used for application.

In order to avoid overtraining problem, the data was split in a training and a testing set. The approach to choose the best network is thus applied to the testing set. This is called the learning procedure.

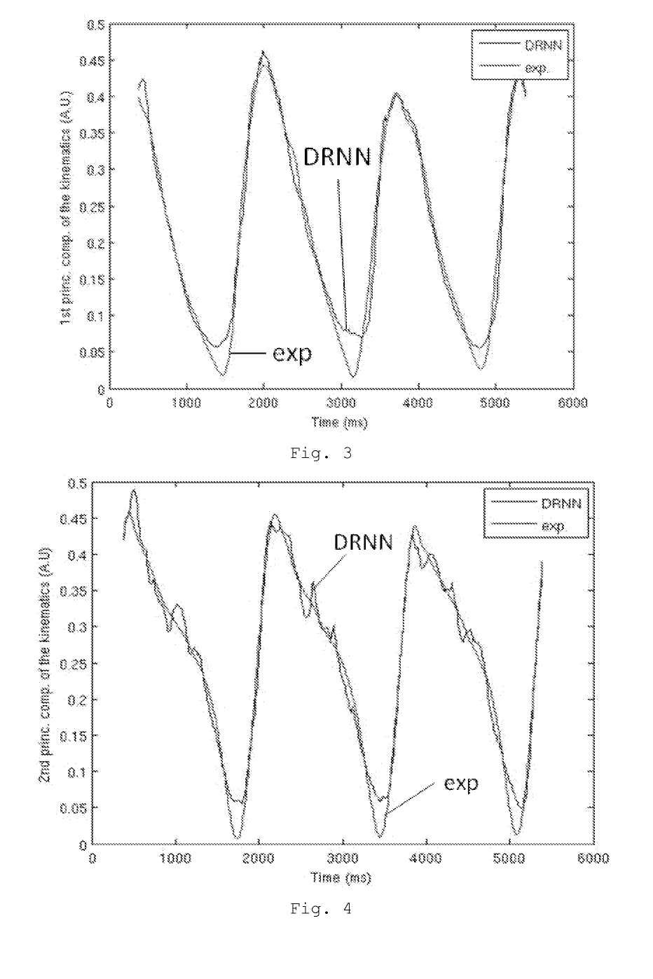

In order to illustrate the improved performance of the new DRNN with respect to the original version (Cheron et Al.), identical input signals and target output signals were used to compare both DRNN. FIGS. 3 and 4 show the performance of the original DRNN at the training level.

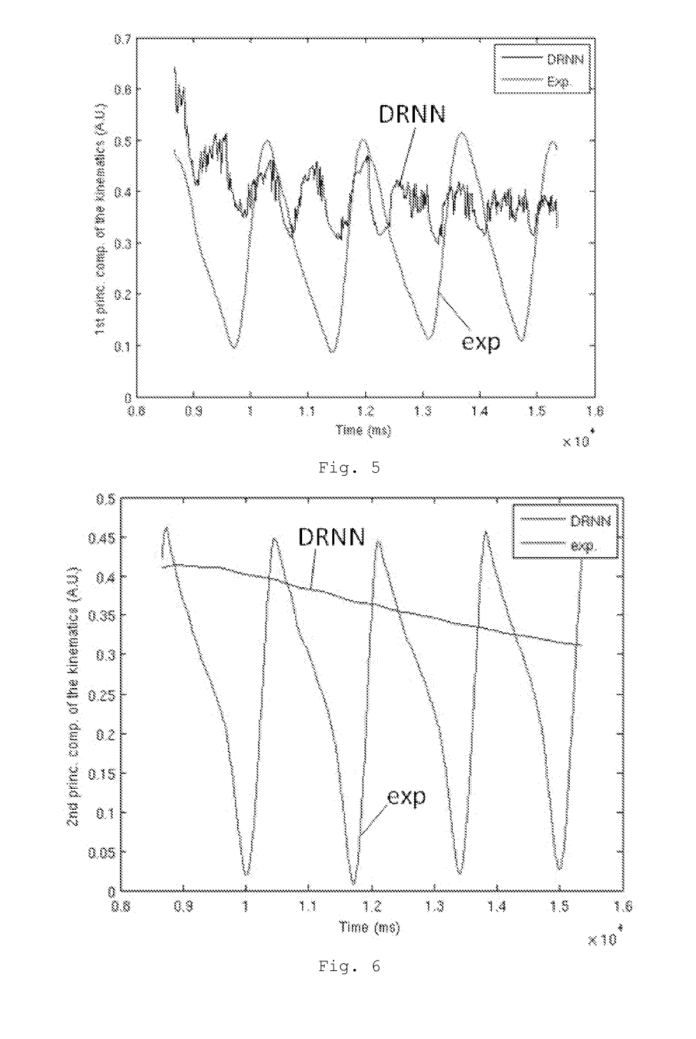

FIGS. 5 and 6 show the performance of the original DRNN at the testing level, using an independent dataset (i.e. not “seen” by the DRNN during its learning phase). The results obtained with the new training procedure shows an important improvement, demonstrating the better behaviour of the DRNN using the modified training procedure described in the previous section.

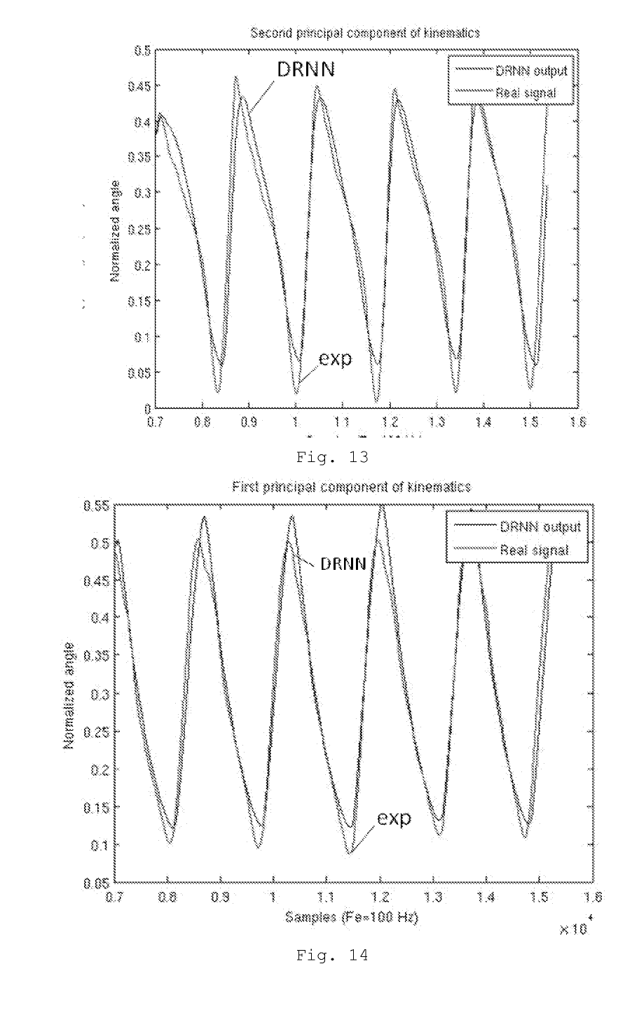

The generalization ability of the new preferred DRNN is clearly improved, as can be checked on FIGS. 13 and 14.

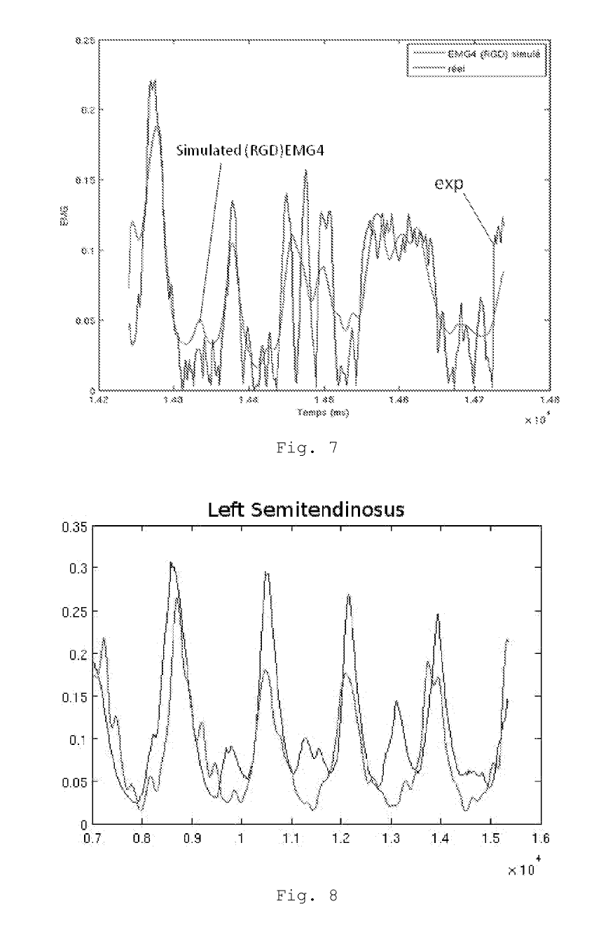

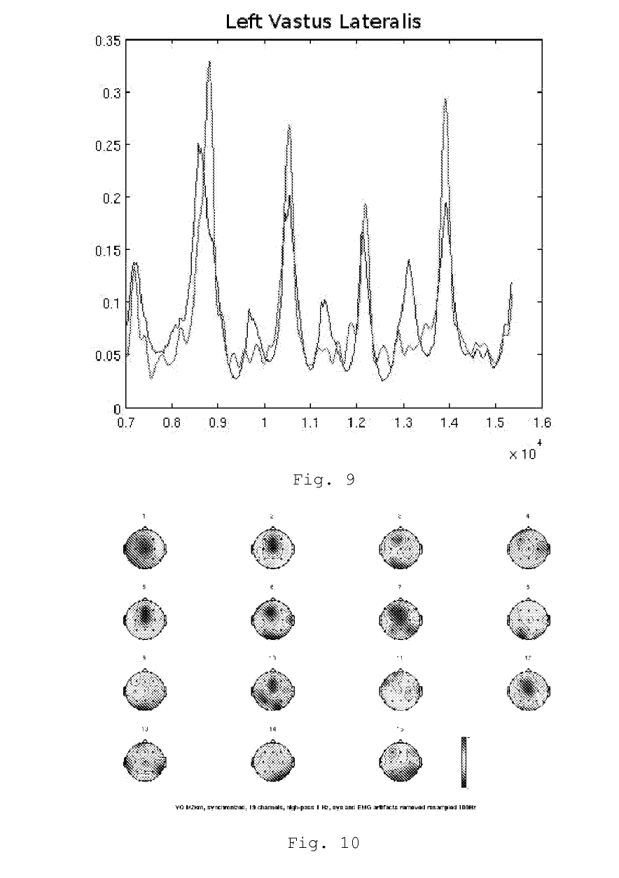

A similar improvement was observed in the simulation of electromyographic signals (EMG) by the DRNN on the basis of the corresponding EEG signals (see FIGS. 7 to 9).

The results of the obtained DRNN can be analyzed on an independent testing data set with good or bad initial conditions and to compare the results with a white noise as input to see the added-value of EEG signals.

The intrinsic properties of the DRNN and the link with the Central Pattern Generator approach (CPG) will then be shown. Explanations of why this system works are argued based on FFT and coherence.

First, it is clear that the DRNN is able to generalize for an independent set. FIG. 13 and FIG. 14 show that the output of the DRNN for new data is quite close to the real measurement.

However, it can be noticed that the first point of the output of the DRNN is the correct measurement.

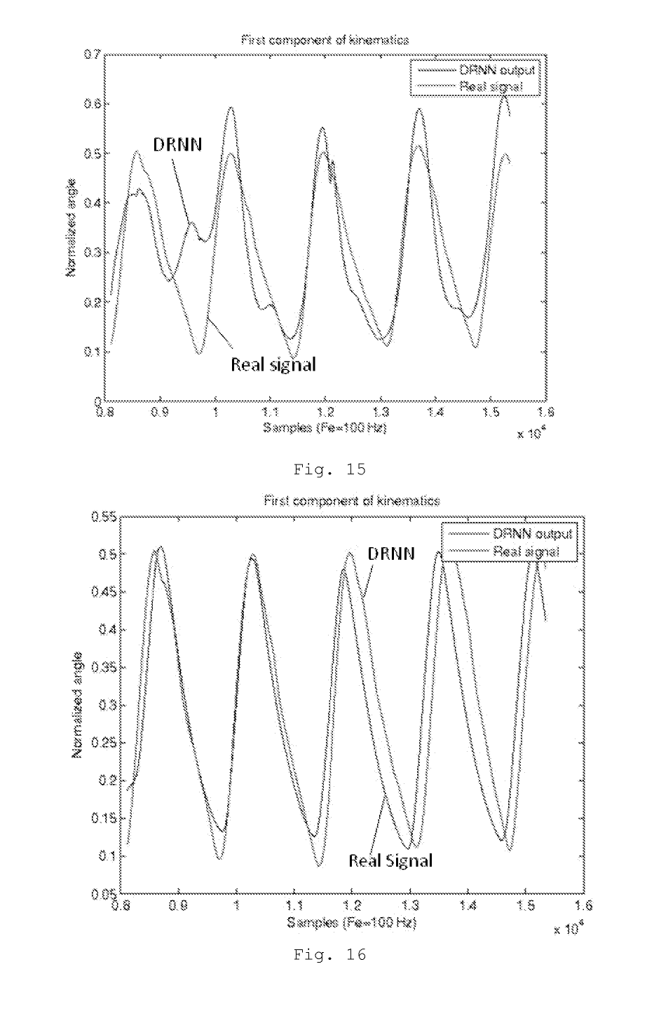

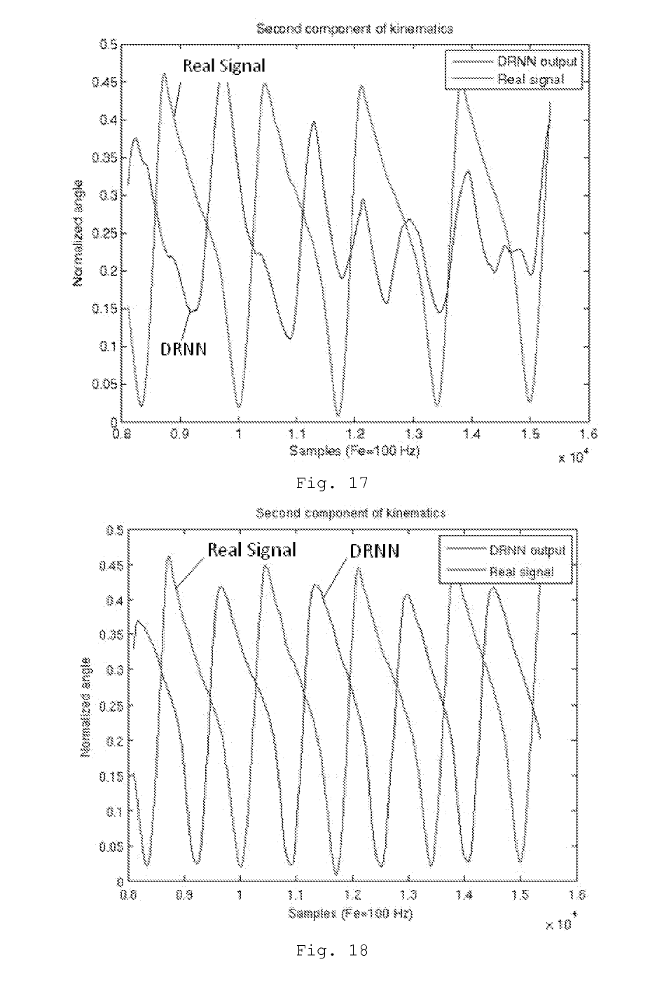

FIG. 15 shows that even if the first point of kinematics is wrong, the DRNN is able to provide good results compared to white noise whose results shown in FIG. 16 are going further and further from the real values. If the first point is very far from the reality, the white noise is completely disabled to find the correct values whereas the ICA components allow to find the correct timing with a certain transient (in CPG, this principle is also checked).

Moreover, if the first kinematic point is still further, the EEG based DRNN takes more time to recover the phase as shown in 15, whereas the white noise is completely wrong as shown in FIG. 18.

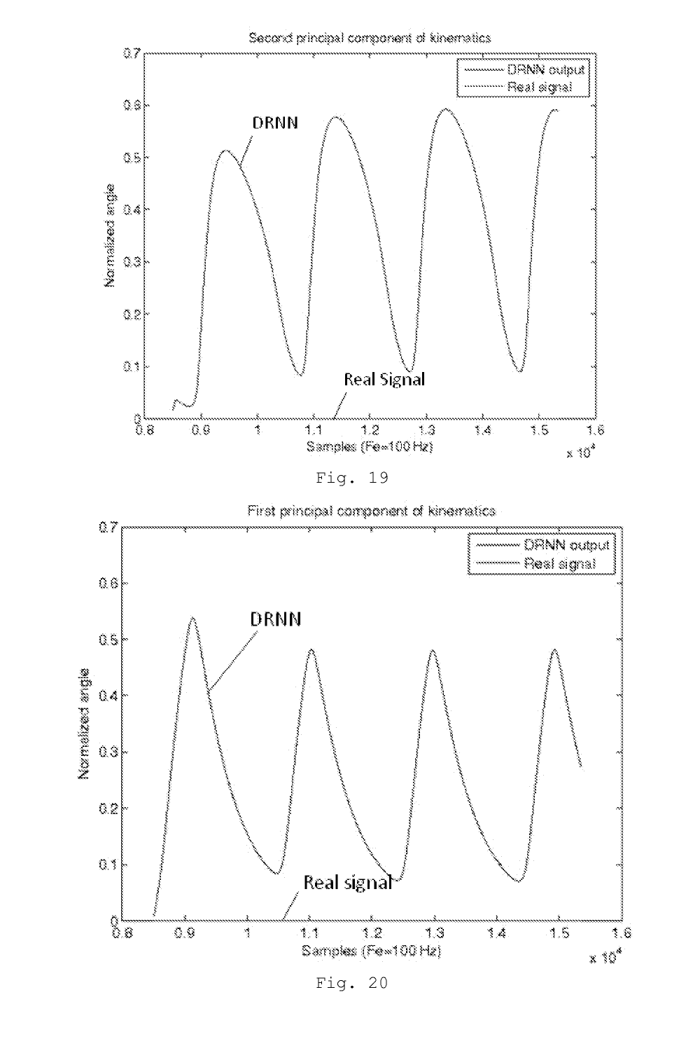

Actually, the DRNN, by the recurrent approach, is able to automatically generate a periodic signal with zero in input as shown in FIG. 19 and FIG. 20. The first part is a transient phenomenon due to the effect of the past of the first point of kinematic put at zero in this case. Then, the stationary response is perfectly periodic.

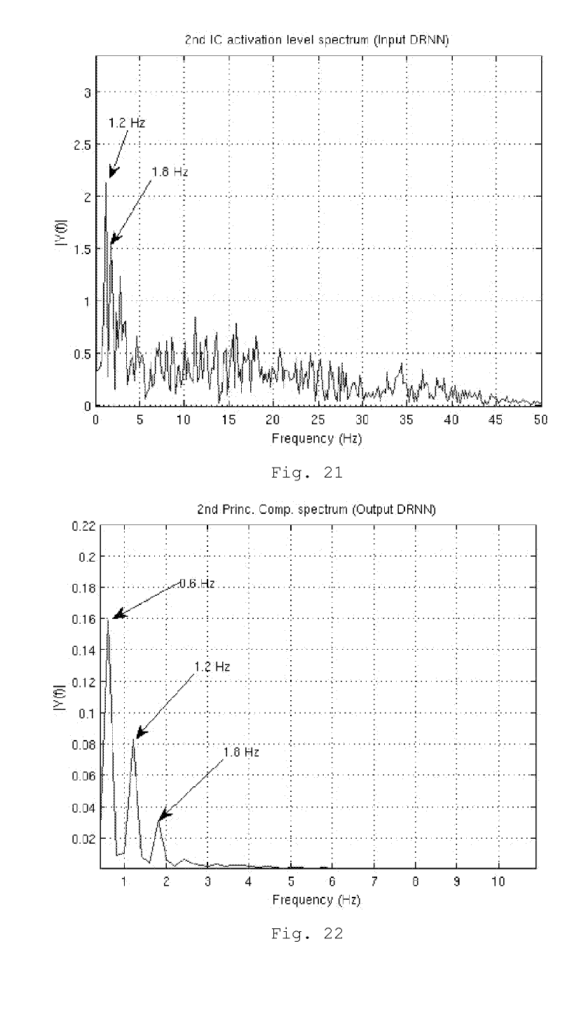

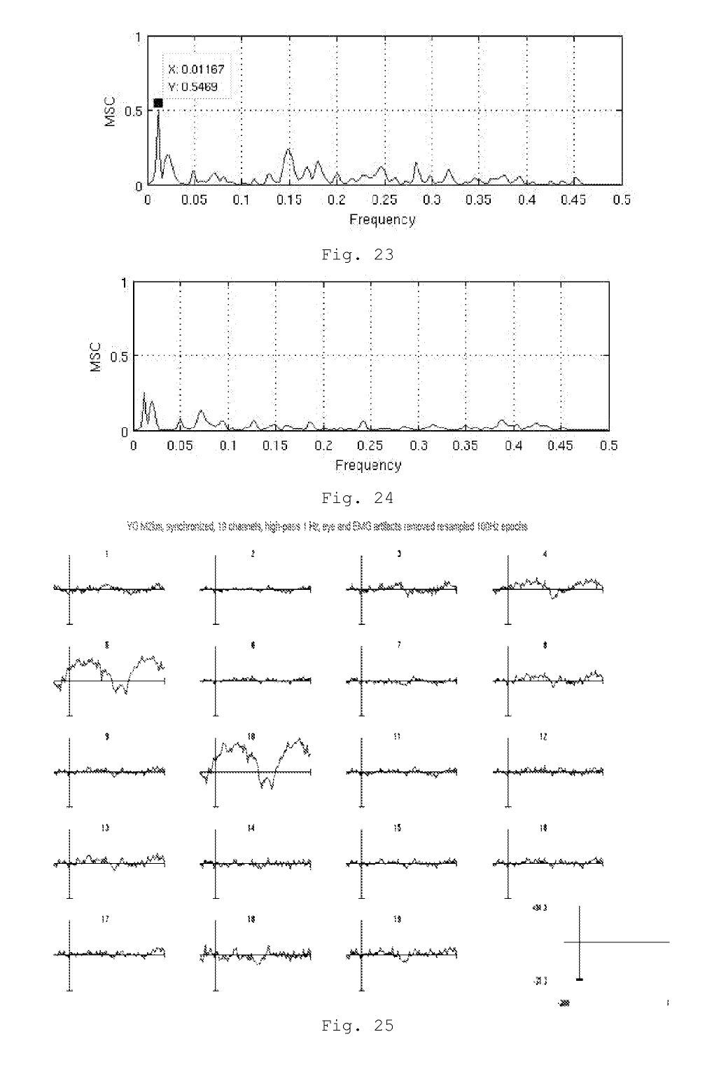

Afterward, FFT of the ICA component presents similar frequencies than those of the kinematics as shown on FIG. 21 for the second ICA component spectrum and FIG. 22 for the spectrum of the second principal component of kinematics. Moreover, coherence between the EEG and EMG shown in FIG. 23 and FIG. 24 are quite high at similar frequencies like for kinematics. All these similarities explain why the DRNN is able to determine the relevant timing. This network is also intrinsically able to generate rhythms like CPGs in animal and human locomotion and matsuoka oscillators in robots and this rhythm is controlled by information present in the ICA components based on EEG.

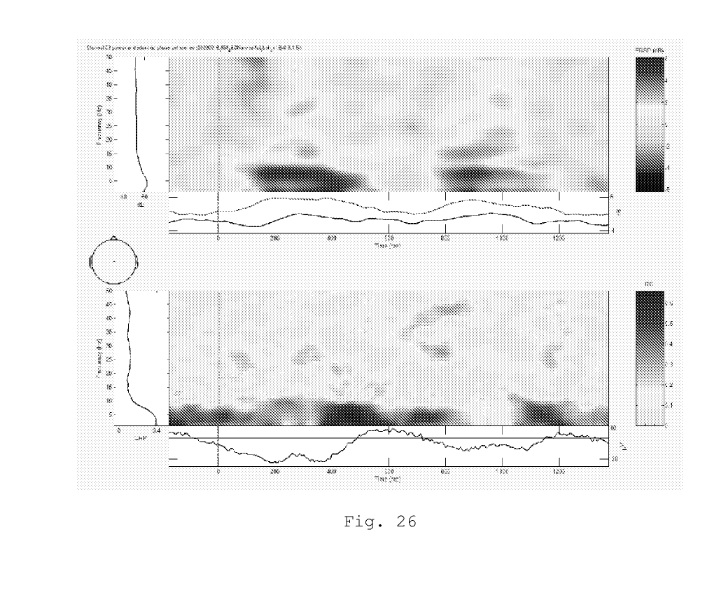

Finally, in FIG. 25, a grand average Event-Related-Potential analysis on a complete walk cycle and considering the heel strike as the event shows clearly the presence of two maxima linked to the two paces of a cycle. This is confirmed in the time frequency representation shown in FIG. 26. Actually, it shows 2 areas easily recognizable on the time-frequency representation.

1. A method to determine an artificial limb movement comprising:
providing an EEG input training dataset comprising an input EEG signal and the corresponding target movement of the artificial limb;
providing an output prosthetic limb movement training dataset corresponding to said EEG input training dataset;
providing a dynamic recurrent neural network (DRNN) comprising a convergence acceleration algorithm;
training said DRNN with said input and output datasets to define synaptic weights w_{i,j} between neurons of said DRNN;
determining from any EEG input dataset the artificial limb movement using the output generated by the trained DRNN in response to said EEG input dataset.

2. A method according to claim 1 wherein the artificial limb movement to be determined is a quasi-periodic limb movement.

3. A method according to claim 1 wherein the DRNN training step further comprises defining all other free parameters of the DRNN.

4. A method according to claim 1 wherein the EEG input signal and the EEG input training dataset are pre-processed using a blind source separation based algorithm.

5. A method according to claim 4 wherein the blind source separation based algorithm filters electromyographic (EMG) and electrooculographic (EOG) artifacts.

6. A method according to claim 1 wherein the EEG input signal and the EEG training dataset are pre-processed by means of Fourier analysis algorithm.

7. A method according to claim 1 wherein relevant information of both the EEG signal and the EEG input training dataset are extracted using an independent component analysis based algorithm.

8. A method according to claim 1 wherein the number of movement variables is reduced by using principal component analysis.

9. A method according to claim 1 wherein the training is performed iteratively and a learning rate ε_{i,j} is associated with a neural connection from neuron i to neuron j, the learning rate ε_{i,j} being increased by a constant coefficient u at each iteration if the product of the gradient of the error function (δE/δw_{i,j (n) at the last two iterations is positive, and the learning rate ε}_{i,j} being decreased by a constant coefficient d at each iteration if the product of gradient of the error function at the last two iterations is negative, u being a number larger than 1, and d being a number comprised between 0 and 1.

10. A method according to claim 9 wherein u is comprised between 1.1 and 1.5 and d is comprised between 0.5 and 0.9.

11. A method according to claim 9 wherein if the error function E(n) increases between two iterations, all the learning rates are divided by a constant factor c:
if E(n+1)>E(n) then ε_{i,j} (n+1)=ε_{i,j} (n)/c, for all i, j, c being a number larger than one, preferably comprised between 1.5 and 5.

12. A method according to claim 9 wherein additional learning rates are associated to all other free parameters of the DRNN.

13. A method according to claim 1 wherein the artificial limb movements to be determined corresponds to lower limb movements.

14. A method according to claim 1 wherein the determined movement is used to simulate corresponding electromyographic signals.

15. A prosthetic limb system comprising:
a prosthetic limb comprising servo-drive means to control prosthetic limb movement;
a sensing means for sensing EEG signal originating from a user brain;
a means for inputting the EEG signal to an artificial neural network;
a means within said neural network for determining an artificial prosthetic limb movement from said EEG signal according to the method of claim 1; and wherein
the output of said neural network is operatively connected to said servo-drive means to control the prosthetic limb movement.

16. A prosthetic limb system according to claim 15 wherein the artificial neural network is a dynamic recurrent neural network.

17. A prosthetic limb system according to claim 15 wherein the prosthetic limb is a lower limb prosthesis.

18. A computer readable medium having computer readable code embodied therein, said computer readable code, when executed on a computer, implementing the method according to claim 1.
